(19) United States
(12) Patent Application Publication
(10) Pub. No.: US 2016/0340488 A1
(43) Pub. Date: Nov. 24, 2016

(54) COMPOSITION OF THERMOPLASTIC ELASTOMER COMPOSITE MATERIAL APPLICABLE TO IN-MOLD FOAMING

(71) Applicant: Eefoam Materials Co., Ltd., Taichung City (TW)

(72) Inventor: CHUN-HSIUNG WU, TAICHUNG CITY (TW)

(21) Appl. No.: 14/720,778

(22) Filed: May 23, 2015

(51) Int. Cl. C08J 9/14

(52) U.S. Cl. CPC C08J 9/14; C08J 2325/06; C08J 2425/08; C08J 2323/12; C08J 2375/04

(57) ABSTRACT

A composition of thermoplastic elastomer composite material applicable to in-mold foaming includes a thermoplastic elastomer, a blowing agent group which is P,P-oxybis benzene sulfonyl hydrazide, and a micro-capsule blowing agent. After the thermoplastic elastomer and the blowing agent group are melt-mixed, granulated, or milled, the composition may be used for in-mold foaming to achieve the effects of controlling the foam size, lowering the defective rate, reducing the waste of materials and the weight, adhering different types of materials, and saving time and material effectively.

### FIELD OF THE INVENTION

The present invention relates to the field of in-mold foaming materials, in particular to the composition of a thermoplastic elastomer composite material applicable to in-mold foaming.

### BACKGROUND OF THE INVENTION

In general, the present existing foaming technology is mainly divided into two types, respectively: out-mold foaming and in-mold foaming.

In the out-mold foaming, an expansion occurs first and then a stable contraction occurs in the foaming process, and thus the size of the foam product cannot be controlled easily. In general, the size of the foam product is bigger than the size of the mold. The unstable size may cause a high defective rate easily, and a too-big foam product also causes an unnecessary waste of materials.

On the other hand, the in-mold foaming is generally used for manufacturing the foam product, in which the size can be controlled more easily. And the waste of materials can be minimized.

However, most of the materials currently used for the in-mold foaming consists of a thermoplastic elastomer and an AC blowing agent (azodicarbonamide), and the density of the foam product made of these materials is still to high (generally over 0.7 g/cm³), so that the lightweight effect cannot be achieved.

In addition, the foam product made of the aforementioned materials requires a complicated manufacturing process for the adhesion of two different materials. The two different types of materials are produced separately, and then the surface of the materials is polished and coated with an appropriate primer and an appropriate adhesive, before the two types of material are adhered with each other. Such manufacturing process usually requires more labor, time and material.

### SUMMARY OF THE INVENTION

In view of the aforementioned drawbacks of the prior art including the difficulty of controlling the size of the foam product made by the materials by the out-mold foaming, the defective rate, and the waste of materials, and the present in-mold foaming failing to achieve the lightweight effect and wasting labor, time and material for adhering different types of materials, it is a primary objective of the present invention to provide a composition of thermoplastic elastomer composite material applicable to in-mold foaming in accordance with the present invention to overcome the drawbacks of the prior art.

To achieve the aforementioned objective, the present invention provides a composition of thermoplastic elastomer composite material applicable to in-mold foaming, and the composition comprises a thermoplastic elastomer with 50-100 parts by weight, and a blowing agent group with 1-10 parts by weight, and the blowing agent group is a mixture of P,P-oxybis benzene sulfonyl hydrazide and a micro-capsule blowing agent in any proportion, such that after the thermoplastic elastomer and the blowing agent group are melted, mixed, granulated or milled, the composition may be used for in-mold foaming. The present invention has the effects of controlling the size, lowering the defective rate, reducing the waste of materials and the weight, adhering different types of materials, and saving time and material effectively.

### BRIEF DESCRIPTION OF THE DRAWING

FIG. 1 is a flow chart of a manufacturing procedure of the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

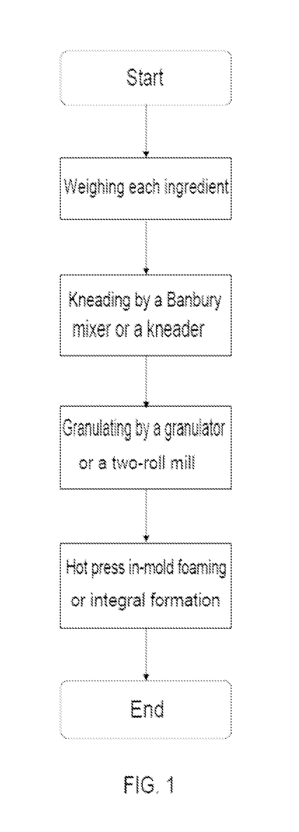

With reference to FIG. 1 for a composition of a thermoplastic elastomer composite material applicable to in-mold foaming in accordance with a preferred embodiment of the present invention, the composition comprises:

a thermoplastic elastomer, which may be polyolefin elastomer, styrenic elastomer or thermoplastic polyurethane elastomer, and the polyolefin elastomer may be polypropylene elastomer or polyethylene elastomer; and

a blowing agent group, which is P,P-oxybis benzene sulfonyl hydrazide (OBSH) blowing agent and a micro-capsule blowing agent.

The aforementioned composition is a composition of thermoplastic elastomer composite material applicable to in-mold foaming in accordance with a preferred embodiment of the present invention, and its manufacturing method and using method are described as follows:

Firstly, the thermoplastic elastomer with an appropriate flowability or an appropriate melt index (MI) is selected and added to a blowing agent group with an appropriate proportion, and then put into a kneader or a Banbury mixer for melting at a high temperature between 90 to 150. After being kneaded uniformly, the melted mixture is put into a single-screw extruder to produce pellets or put into a two-roll mill to produce sheets ready for use.

The aforementioned pellets or sheets are weighed before they are put into a mold in a hot-pressed molding machine at a set temperature. The in-mold foaming is completed after the pellets or sheets are heated (at 150 to 170), foamed, and cooled.

In the composition of thermoplastic elastomer composite material applicable to in-mold foaming in accordance with the present invention, the foam size can be controlled, so that the in-mold foaming can be performed successfully to obtain a foam product with a density as low as 0.2 g/cm³, so as to achieve the lightweight effect.

In addition, the composition of thermoplastic elastomer composite material applicable to in-mold foaming in accordance with the present invention has the characteristic of being expanded slower, so that the foaming of a thermoplastic elastomer can be completed with another non-foaming material (such as an unvulcanized rubber sheet) in the same mold. Since the vulcanization of the rubber sheet and the foaming, adhering of the thermoplastic elastomer are performed in one step, the product of a foam with rubber sheet attached together can be manufactured quickly without the use of adhesive.

Secondly, the present invention further includes a polymer material in the mixing process, wherein the polymer material is any one selected from styrene-butadiene-styrene (SBS), styrene-ethylene/butylene-styrene (SEBS) and their oil-extended composite materials.

In addition, the present invention further includes a cross-linking agent in the mixing process, wherein the cross-linking agent is one selected from dicumyl peroxide, 2,5-(tert-butylperoxide)-2,5-dimethylhexane and di-(tert-butyl peroxy-isopropyl) benzene.

In addition, the present invention further includes a filler in the mixing process, wherein the filler is calcium carbonate, talc or any other inorganic mineral.

Further, the present invention includes a compatibilizer in the mixing process, wherein the compatibilizer is anhydride-grafting or its anhydride copolymer.

The present invention further includes a cross-linking coagent in the mixing process, wherein the cross-linking coagent is any one selected from tri allyl cyanurate (TAC) and tri allyl isocyanurate (TAIC).

In the first embodiment, 90 parts by weight of styrenic elastomer, 5 parts by weight of styrene-ethylene/butylene-styrene (SEBS) and their oil-extended composite material (obtained from dipping in styrene-ethylene/butylene-styrene (SEBS) and paraffin oil before being granulated), 2.5 parts by weight of P,P-oxybis benzene sulfonyl hydrazide, 3.5 parts by weight of a micro-capsule blowing agent, 0.8 parts by weight of dicumyl peroxide and 0.2 parts by weight of tri allyl cyanurate (TAC) are melt-mixed in a kneader at a high temperature of 100. After being melted uniformly, the melted mixture is then put into a single-screw extruder to produce pellets. After being weighted, the aforementioned pellets are put into a mold in a hot-pressed molding machine at a set temperature, and the in-mold foaming is completed after the pellets are heated at 150, foamed, and cooled, and the foam product has a density of 0.28 g/cm³.

In the second embodiment, 65 parts by weight of polypropylene elastomer, 2 parts by weight of P,P-oxybis benzene sulfonyl hydrazide, 4 parts by weight of a micro-capsule blowing agent, 5 parts by weight of styrene-butadiene-styrene (SBS) and its oil-extended composite material, 30 parts by weight of styrene-ethylene/butylene-styrene (SEBS) and its oil-extended composite material, 1.5 parts by weight of dicumyl peroxide and 1.2 parts by weight of tri allyl cyanurate (TAC) are melt-mixed in a kneader at a temperature of 120. After being melted uniformly, the melted mixture is put into a two-roll mill to produce sheets. After being weighed, the sheets are put into a mold in a hot-pressed molding machine at a set temperature. The in-mold foaming is completed after the sheets are heated at 170, foamed and cooled, and the foam product has a density of 0.24 g/cm³.

In the third embodiment, 50 parts by weight of thermoplastic polyurethane elastomer, 2 parts by weight of P,P-oxybis benzene sulfonyl hydrazide, 3 parts by weight of a micro-capsule blowing agent, 40 parts by weight of styrene-butadiene-styrene (SBS) and its oil-extended composite material, 0.5 parts by weight of di-(tert-butyl peroxy-isopropyl) benzene, 0.1 parts by weight of tri allyl isocyanurate (TAIC), 5 parts by weight of calcium carbonate and 5 parts by weight of maleic anhydride and polyethylene grafting copolymer or (a grafting copolymer of maleic anhydride and EVA) are melt-mixed in a kneader at a temperature of 150. After being melted uniformly, the mixture is put into a two-roll mill to produce sheets. After being weighed, the aforementioned sheets are put into a mold in a hot-pressed molding machine at a set temperature. The in-mold foaming is completed after the sheets are heated at 170, foamed, and cooled, and the foam product has a density of 0.33 g/cm³.

While the invention has been described by means of specific embodiments, numerous modifications and variations could be made thereto by those skilled in the art without departing from the scope and spirit of the invention set forth in the claims.

What is claimed is:

1. A composition of a thermoplastic elastomer composite material applicable to in-mold foaming, comprising:
a thermoplastic elastomer, with 50-100 parts by weight; and
a blowing agent group, with 1-10 parts by weight, and being a mixture of P,P-oxybis benzene sulfonyl hydrazide and a micro-capsule blowing agent in any proportion;
thereby, after the thermoplastic elastomer and the blowing agent group are melted, mixed, granulated or milled, the composition may be used for in-mold foaming.

2. The composition of thermoplastic elastomer composite material applicable to in-mold foaming as claimed in claim 1, wherein the thermoplastic elastomer is one selected from the group consisting of a polyolefin elastomer, a styrenic elastomer, and a thermoplastic polyurethane elastomer.

3. The composition of thermoplastic elastomer composite material applicable to in-mold foaming as claimed in claim 2, wherein the polyolefin elastomer is one selected from the group consisting of a polypropylene elastomer and a polyethylene elastomer.

4. The composition of thermoplastic elastomer composite material applicable to in-mold foaming as claimed in claim 1, further comprising a polymer material with a consumption of 1-50 parts by weight, and the polymer material being styrene-butadiene-styrene (SBS) and an oil-extended composite material thereof.

5. The composition of thermoplastic elastomer composite material applicable to in-mold foaming as claimed in claim 1, further comprising a polymer material with a consumption of 1-50 parts by weight, and the polymer material being styrene-ethylene/butylene-styrene (SEBS) and an oil-extended composite material thereof.

6. The composition of thermoplastic elastomer composite material applicable to in-mold foaming as claimed in claim 1, further comprising a cross-linking agent with a consumption of 0.1-3 parts by weight, and the cross-linking agent being one selected from the group consisting of dicumyl peroxide, 2,5-(tert-butylperoxide)-2,5-dimethylhexane, and di-(tert-butyl peroxy-isopropyl) benzene.

7. The composition of thermoplastic elastomer composite material applicable to in-mold foaming as claimed in claim 1, further comprising a cross-linking coagent with a consumption of 0.1-3 parts by weight, and the cross-linking coagent being one selected from the group consisting of tri allyl cyanurate (TAC) and tri allyl isocyanurate (TAIC).

8. The composition of thermoplastic elastomer composite material applicable to in-mold foaming as claimed in claim 1, further comprising a filler with a consumption of 1-50 parts by weight, and the filler being one selected from the group consisting of calcium carbonate and talc.

9. The composition of thermoplastic elastomer composite material applicable to in-mold foaming as claimed in claim 1, further comprising a compatibilizer with a consumption of 3-10 parts by weight, and the compatibilizer being one selected from the group consisting of an anhydride-grafting and an anhydride copolymer thereof.

10. The composition of thermoplastic elastomer composite material applicable to in-mold foaming as claimed in claim 9, wherein the compatibilizer is a grafting copolymer of maleic anhydride and polyethylene (or ethylene vinyl acetate, EVA), or a copolymer of styrene and maleic anhydride.
